(19) United States
(12) Patent Application Publication
(10) Pub. No.: US 2011/0031272 A1
(43) Pub. Date: Feb. 10, 2011

(54) CHEMICAL DISPENSING SYSTEMS AND POSITIVE DISPLACEMENT FLOW METERS THEREFOR

(75) Inventors: Brian D. Comiskey, Coto de Caza, CA (US); Rocklin Verespej, Lake Forest, CA (US); Sven Schmode, Buena Park, CA (US)

Correspondence Address: STOUT, UXA, BUYAN & MULLINS LLP, 4 VENTURE, SUITE 300, IRVINE, CA, 92618, US

(73) Assignee: KNIGHT, LLC, Lake Forest, CA (US)

(21) Appl. No.: 12/850,922

(22) Filed: Aug. 5, 2010

Related U.S. Application Data
(60) Provisional application No. 61/231,629, filed on Aug. 5, 2009.

(51) Int. Cl. B67D 7/06; G01F 1/56; G01F 25/00; B67D 7/70

(52) U.S. Cl. 222/23; 73/861.08; 73/1.36; 222/135; 222/138

(57) ABSTRACT

A volume-based, rather than time-based, system for dispensing fluid incorporates a microprocessor-based controller, software, pump, and positive displacement flow meter. The volume being pumped and the time it takes to pump that volume is calculated and tracked by the software, giving a flow rate. This rate is then tracked by the software for any changes. Any conditional changes that occur, affecting this rate, are tracked, and if the rate becomes too excessive outside of the normal rate established at initial calibration, then an alarm or other indication is provided to the operator.

This application claims the benefit under 35 U.S.C. 119(e) of the filing date of Provisional U.S. Application Ser. No. 61/231,629, entitled Chemical Dispensing Systems and Positive Displacement Flow Meters Therefor, and filed on Aug. 5, 2009, which application is expressly incorporated herein by reference, in its entirety.

### BACKGROUND OF THE INVENTION

This invention relates generally to methods and apparatus for controlling the distribution of chemical solutions, and more particularly to innovative positive displacement flow meters and systems for using these flow meters to calibrate pumps in such systems and to trigger alarms if the system operates outside of predetermined parameters.

Dispensing of chemicals into the industrial markets is currently done using a time-based approach. A pump is used, and the amount of chemical to deliver, inject or dilute in the process for which the system is to be employed is determined at the time of system installation. This determination is made by running the pump for a certain period of time and using a container having a known volume (typically a graduated cylinder). Once the desired volume of fluid has been dispensed into the container of known volume, the time elapsed since the dispensing process began is noted. Typically, this time is then programmed into the control unit for the dispensing system, and the unit is set to run for the same time cycle duration repeatedly, under the assumption that the dispensed volume over time will be consistent through repeated dispensing cycles.

This type of fluid dispensing is common in industrial applications, where concentrated chemicals are purchased and connected to a chemical dispenser, and then the concentrated chemical is mixed with water or another chemical at the point of use or just prior to the point of use. An example of this would be in industrial laundries where chemicals are blended with water and then delivered to the washers to wash lines or other fabrics. Also, this type of process is common in the food and beverage industry where sanitation chemicals are purchased and stored in concentrate, away from the processing equipment. After the dispensing system has stopped producing product (typically at the end of a work shift), the chemicals are dispensed with water to predetermined correct dilution ratios, and then used for cleaning and sanitation. Additionally, such systems are often used in medical applications where equipment must be cleaned prior to sterilization, and the concentrated enzymes are mixed with water for instrument cleaning. Another application is in the dairy industry, wherein chemical dispensing systems of the type contemplated in this patent application may be used for the purpose of sterilizing dairy cows.

Unfortunately, there are a number of problems with this time-based approach to volumetric control. Often, peristaltic pumps, having associated rubber tubing, are utilized. As the rubber tubing degrades with time and usage, the volumetric flow generated by the pump in the originally calibrated period of time can substantially decrease, leading to a chronic problem with below optimal volumetric output. There are other system changes over time, as well, which can lead to fluid output changes from the dispensing system.

### SUMMARY OF THE INVENTION

The present invention solves the problems and shortcomings of a time based dispensing system by using a volume-based approach to dispensing. This is done with a microprocessor-based controller, software, pump, and positive displacement flow meter. The calculation of the volume being pumped and the time it takes to pump that volume is tracked by the software, giving a flow rate. This rate is then tracked by the software for any changes. Any conditional changes that occur, affecting this rate, are tracked, and if the rate becomes too excessive outside of the normal rate established at initial calibration, then an alarm is sounded.

Advantages of the inventive system, which uses a positive displacement flow meter in conjunction with a controller, instead of a time-based dispensing protocol driven by the dispenser's controller alone, include the following. First, the system does not need a re-calibration after the initial calibration. Second, the flow meter can detect when the dispenser is out of product, because the flow meter detects a different rate and the controller interrupts this signal as an error. Third, by using a flow meter with the controller, any change with the controller or any change in system components due to wearing, for example, can be detected by the flow meter and interpreted as a change in the system response, thus alarming the user. Prior to this occurrence, the system can compensate for any wearing components by not running based upon time elapsed, but rather by running on a volume-based flow measurement.

More particularly, there is provided a chemical fluid dispensing system, which comprises a controller having a microprocessor and a user interface, a first pump for pumping a first fluid through a first fluid line into a mixing chamber, and a second pump for pumping a second fluid through a second fluid line into the mixing chamber. A first flow meter is disposed in the first fluid line, and a second flow meter is disposed in the second fluid line. A feedback loop extends from each of the first and second flow meters back to the controller, for closed loop control of the system. Each of the first and second flow meters comprise positive displacement flow meters. Preferably, the system further comprises an alarm for indicating an out of tolerance fluid flow volume through one of the first and second flow meters. Check valves are preferably provided in each fluid line between the pump and flow meter, as well as between the flow meter and the mixing chamber. A water inlet assembly is provided for delivering water through a third fluid line into the mixing chamber. A third flow meter is disposed in the third fluid line.

Advantageously, each of the first and second flow meters comprise positive displacement flow meters. Each positive displacement flow meter comprises a flow meter housing, comprising a flow meter body having a gear cavity, a fluid inlet, a fluid outlet, a gear cover assembly, and a sensor cover. The flow meter additionally comprises a gear, preferably oval in configuration, which may be disposed on a first gear post in the gear cavity, and a gear-magnet assembly, also preferably oval in configuration, which may be disposed on a second gear post in the gear cavity. A sensor, preferably a Hall-effect sensor, is provided for counting rotations of the oval gear-magnet assembly.

An advantageous feature of the present invention is an ability to adapt a common flow meter design for different desired volumetric flow rates. Thus, the gear cover assembly comprises a protruding step which extends downwardly into the gear cavity when the gear cover assembly is attached to the flow meter body. The protruding step extends downwardly a first predetermined distance when the flow meter is adapted for a first predetermined flow rate, and a different second predetermined distance when the flow meter is adapted for a second different predetermined flow rate. This is accomplished, of course, by utilizing two different gear cover assemblies, depending upon the desired flow rate for the flow meter. The reason for these differently sized protruding steps is for accommodating oval gears of differing vertical heights, depending upon the flow rate desired. Therefore, in accordance with this unique design feature, the oval gear and the oval gear magnet assembly have a first predetermined vertical height when the flow meter is adapted for a first predetermined flow rate, and a different second predetermined height when the flow meter is adapted for a second different predetermined flow rate.

In another aspect of the invention, there is provided a positive displacement flow meter having a flow meter housing, and comprising a flow meter body having a gear cavity, a fluid inlet, a fluid outlet, a gear cover assembly, and a sensor cover. The flow meter additionally comprises an oval gear which may be disposed on a first gear post in the gear cavity and an oval gear-magnet assembly which may be disposed on a second gear post in the gear cavity. A sensor, preferably a Hall-effect sensor, is provided for counting rotations of the oval gear-magnet assembly.

An advantageous feature of the present invention is an ability to adapt a common flow meter design for different desired volumetric flow rates. Thus, the gear cover assembly comprises a protruding step which extends downwardly into the gear cavity when the gear cover assembly is attached to the flow meter body. The protruding step extends downwardly a first predetermined distance when the flow meter is adapted for a first predetermined flow rate, and a different second predetermined distance when the flow meter is adapted for a second different predetermined flow rate. This is accomplished, of course, by utilizing two different gear cover assemblies, depending upon the desired flow rate for the flow meter. The reason for these differently sized protruding steps is for accommodating oval gears of differing vertical heights, depending upon the flow rate desired. Therefore, in accordance with this unique design feature, the oval gear and the oval gear magnet assembly have a first predetermined vertical height when the flow meter is adapted for a first predetermined flow rate, and a different second predetermined height when the flow meter is adapted for a second different predetermined flow rate.

In yet another aspect of the invention, there is disclosed a method of calibrating a fluid dispensing system, which comprises steps of pumping a liquid, having known flow characteristics, through a flow meter and into a reservoir having a known or measurable volume, and counting the number of rotations of a gear in the flow meter while the known volume of fluid is pumped through the flow meter. This number of rotations, and the known volume of fluid, are then recorded. The inventive method may be repeated for a second liquid having different known flow characteristics and/or at different ambient temperatures.

In still another aspect of the invention, there is disclosed a method of modifying a fluid flow capacity of a positive displacement flow meter comprising a flow meter body having a gear cavity, a fluid inlet, and a fluid outlet. The inventive method comprises a step of removing a first gear cover assembly having a protruding step which extends a particular distance downwardly into the gear cavity when the first gear cover assembly is attached to the flow meter body. A first set of gears having a first predetermined vertical height from the gear cavity are then removed, and replaced with a second set of gears having a second predetermined vertical height. A second gear cover assembly having a protruding step which extends a different particular distance downwardly into the gear cavity is then attached to the flow meter body.

The invention, together with additional features and advantages thereof, may be best understood by reference to the following description taken in conjunction with the accompanying illustrative drawings. In these accompanying drawings, like reference numerals designate like parts throughout the figures.

### BRIEF DESCRIPTION OF THE DRAWINGS

FIG. 1 is a schematic view of a fluid dispensing system constructed in accordance with the principles of the present invention;

FIG. 2 is a schematic view of a control system that may be utilized with a dispensing system like that illustrated in FIG. 1;

FIG. 3 is a schematic view of a multiple pump chemical dispensing system which utilizes a positive displacement flow meter of the type disclosed in this application for closed-loop control;

FIG. 4 is an isometric view of a positive displacement flow meter constructed in accordance with the principles of the present invention;

FIG. 5 is a top view of the flow meter of FIG. 4;

FIG. 6 is a cross-sectional view, taken along lines 6-6 of the flow meter of FIG. 5;

FIG. 7 is a side view of the flow meter of FIG. 5;

FIG. 8 is a bottom view of the flow meter of FIG. 5;

FIG. 9 is an end view of the flow meter of FIG. 8;

FIG. 10 is an exploded assembly view of the flow meter of FIGS. 4-9;

FIG. 11 is an isometric view of the body of the flow meter of FIGS. 4-9;

FIG. 12 is an isometric view illustrating a different orientation of the flow meter body shown in FIG. 11;

FIG. 13 is a top view of the flow meter body of FIGS. 11 and 12;

FIG. 14 is a left side view of the flow meter body of FIG. 13;

FIG. 15 is a right side view of the flow meter body of FIG. 13;

FIG. 16 is a bottom view of the flow meter body of FIG. 13;

FIG. 17 is a top view of a gear cover of a flow meter of the present invention;

FIG. 18 is a cross-sectional view taken along lines 18-18 of the gear cover of FIG. 17;

FIG. 19 is a side view of the gear cover of FIG. 17;

FIG. 20 is a bottom view of the gear cover of FIG. 17;

FIG. 21 is an isometric view of the gear cover of FIGS. 17-20;

FIG. 22 is a top view of another embodiment of a gear cover of a flow meter of the present invention;

FIG. 23 is a cross-sectional view taken along lines 23-23 of the gear cover of FIG. 22;

FIG. 24 is a side view of the gear cover of FIG. 22;

FIG. 25 is a bottom view of the gear cover of FIG. 22;

FIG. 26 is an isometric view of the gear cover of FIGS. 22-25;

FIG. 27 is a top view of a relatively high volume flow meter constructed in accordance with the principles of the present invention;

FIG. 28 is a cross-sectional view taken along lines 28-28 of FIG. 27;

FIG. 29 is a top view similar to FIG. 27 of a relatively low volume flow meter constructed in accordance with the principles of the present invention;

FIG. 30 is a cross-sectional view taken along lines 30-30 of FIG. 29;

FIG. 31 is a top view of an oval gear employed in the flow meter of the present invention;

FIG. 32 is an isometric view of the gear shown in FIG. 31;

FIG. 33 is a side view of the gear shown in FIGS. 31-32; and

FIG. 34 is an enlarged top view of the gear shown in FIG. 31, showing additional constructional details thereof.

### DESCRIPTION OF THE PREFERRED EMBODIMENT

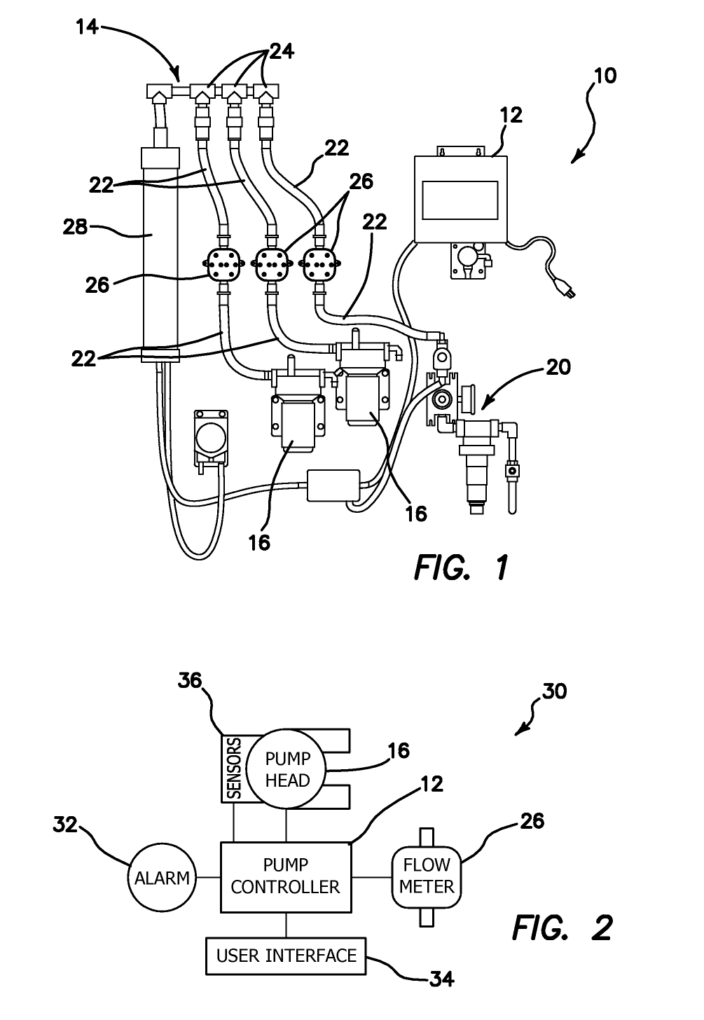

Referring now more particularly to the drawings, there is shown in FIG. 1 a schematic view of a fluid dispensing system 10. The system 10, as illustrated, comprises a control unit 12, a mixing channel 14, a first pump 16, a second pump 16, and a water inlet assembly 20. Fluid lines 22 extend between each of the pumps 16, and the water inlet assembly 20 and fittings 24 on the mixing chamber 14. Flow meters 26, constructed in accordance with the principles of the present invention, are disposed in each of the fluid lines 22, as shown. A mixing reservoir 28 is also fluidly connected to the mixing chamber 14, for purposes to be described below.

FIG. 2 illustrates a control system 30 which may be used in connection with a dispensing system like the system 10 shown in FIG. 1. The control system 30 comprises the pump controller 12, a pump head 16, and a flow meter 26. Additional components which are connected to the control unit 12 comprise an alarm 32, which may be audible, visual, or both, a user interface 34 for operating the control unit 12, and sensors 36 which are also connected to the pump 16.

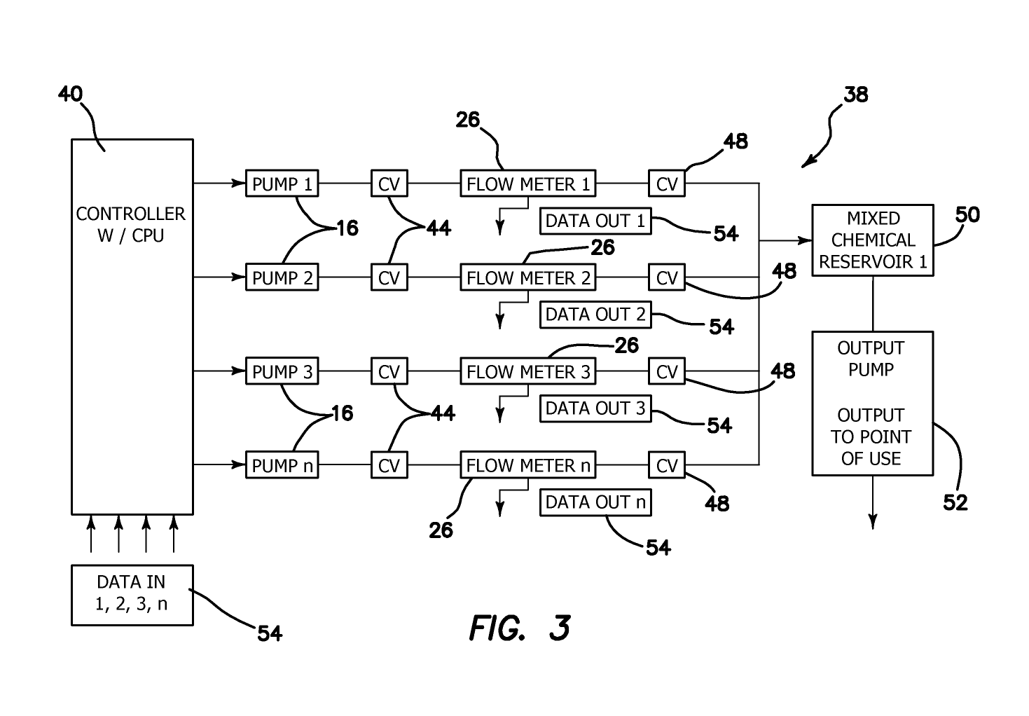

FIG. 3 illustrates another variant of a fluid dispensing system 38 having a control unit 40, wherein like elements to those in the embodiment of FIGS. 1 and 2 are designated by like reference numerals. The fluid dispensing system 38 employs multiple pumps 16, all commonly controlled by the control unit 40. Downstream of each pump 16 is disposed a check valve 44. The check valves 44 are optional, but offer at least two advantages to the system, as will be described below. Flow meters 26 are disposed in line downstream of each of the check valves 44, respectively. Downstream of each flow meter 26 is disposed a second check valve 48. Four pumps 16 are shown, but this is by example only. In actuality, n pumps could be employed, wherein the variable n is dependent upon the number of different chemicals to be injected into the desired chemical solution, which is contained in a mixed chemical reservoir 50. Downstream of this reservoir 50 is an output pump 52 which delivers the chemical solution from the reservoir 50 to the desired point or points of use. As shown in the schematic FIG. 3, there is a feedback loop 54 for transmitting flow rate data from each flow meter 26 back to the controller 40, for closed loop control.

As stated above, check valves 44 are optional, though preferred. At least two advantages of the check valves 44 are that, first, they assist in helping to avoid draining their corresponding flow meter 26, and second, the check valves 44 act as pulsation dampeners. As will be explained more fully below, the system 38 operates partially using rotation counting sensors associated with the gears in the flow meters 26. These sensors are preferably Hall effect sensors, which operate using magnets having opposed polarity, which count half-rotations of the gearing and set and re-set with each such half rotation. If there is excessive pulsation in the flow meter, this can cause the sensors to erroneously record extra half rotations as the gears “dither” responsive to the pulsations. Such sensor errors can cause the system to operate less efficiently.

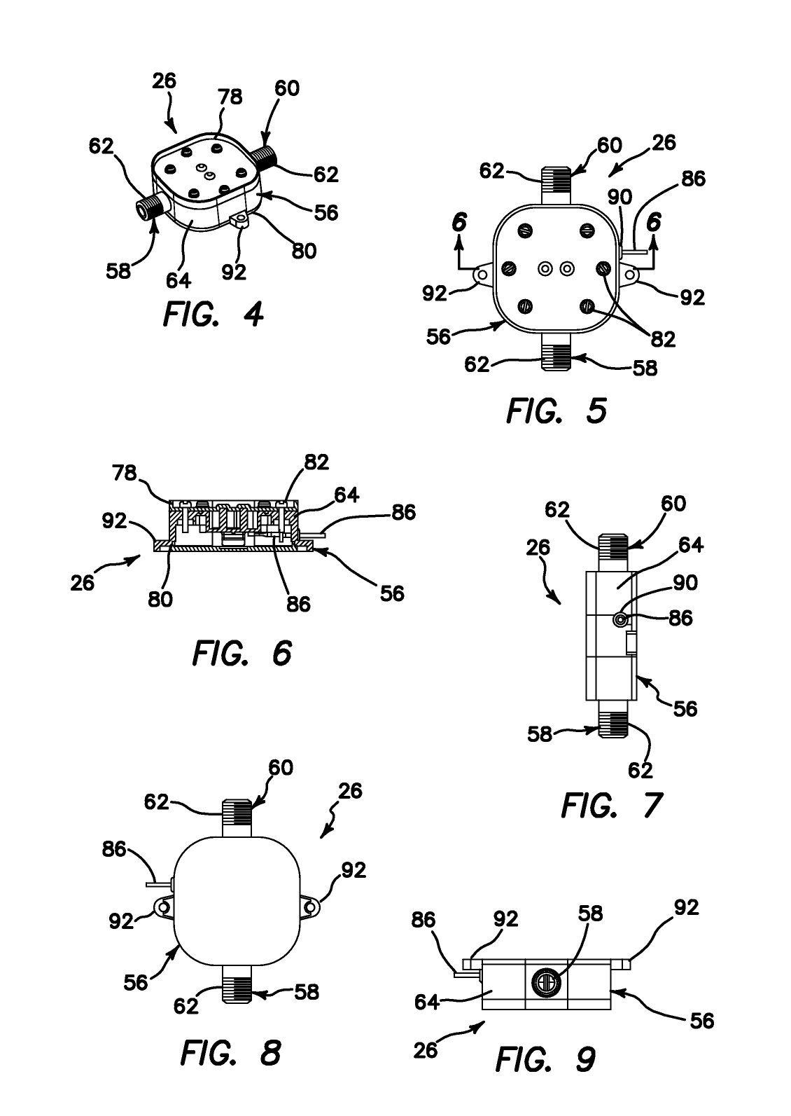

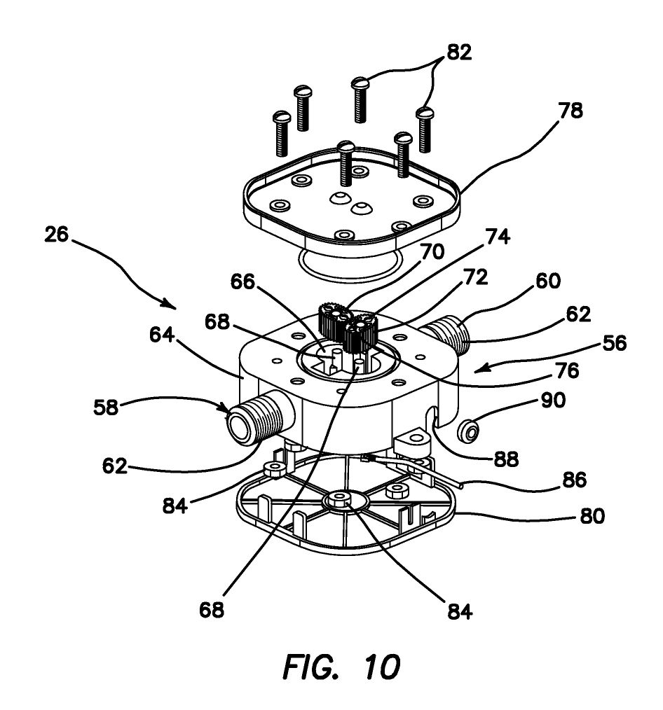

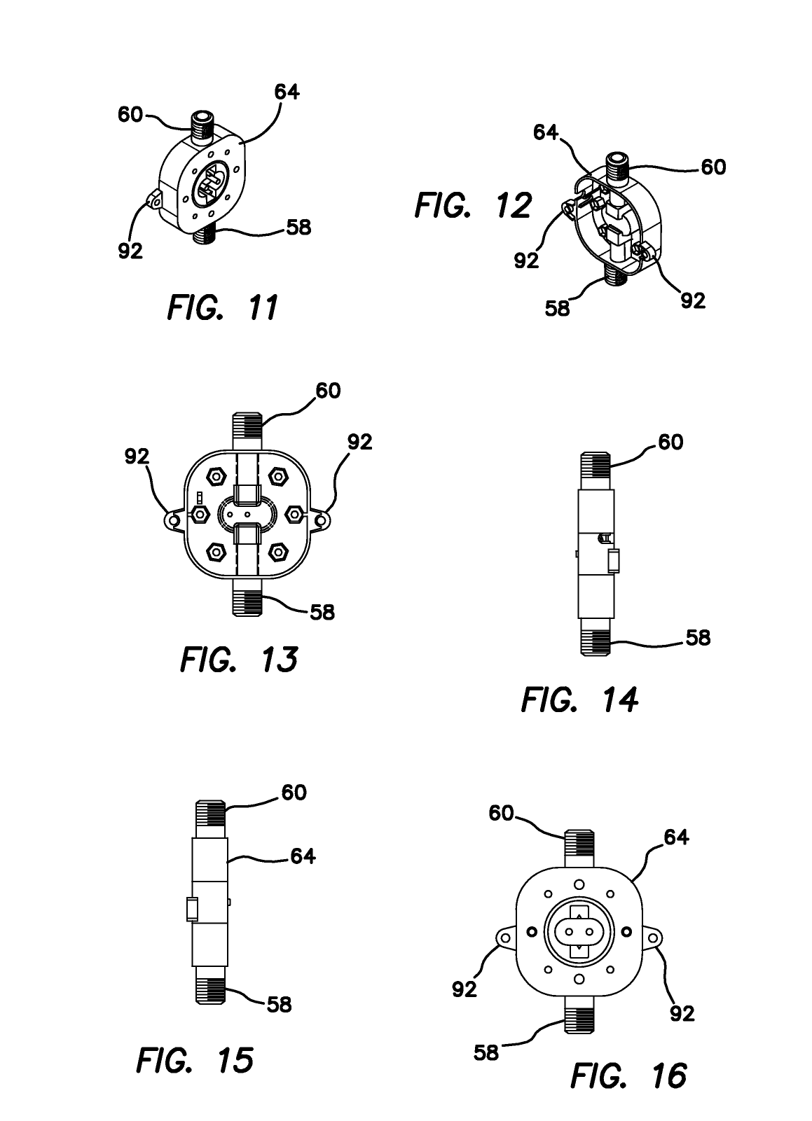

FIGS. 4-10 illustrate the detailed constructional features of one particular embodiment of a flow meter 26. The flow meter 26 comprises a housing 56, a fluid inlet 58 and a fluid outlet 60. External threads 62 are provided on each of the fluid inlet and outlet 58, 60, respectively, to enable convenient coupling of the flow meter 26 into a fluid dispensing system 10, 38. The housing 56 comprises a flow meter body 64, which is illustrated in more detail in FIGS. 11-16. The housing 56 further comprises a gear cavity 66, in which are disposed two gear posts 68. An oval gear 70 is disposed on one of the gear posts 68, as shown. An oval gear-magnet assembly 72 is disposed on the other of the gear posts 68. The oval gear 70 and the oval gear-magnet assembly 72 are similarly constructed, except that the gear magnet assembly includes a Hall-effect sensor therein, comprising a first magnet 74 and a second magnet 76, wherein the two magnets 74, 76 are of opposite polarity.

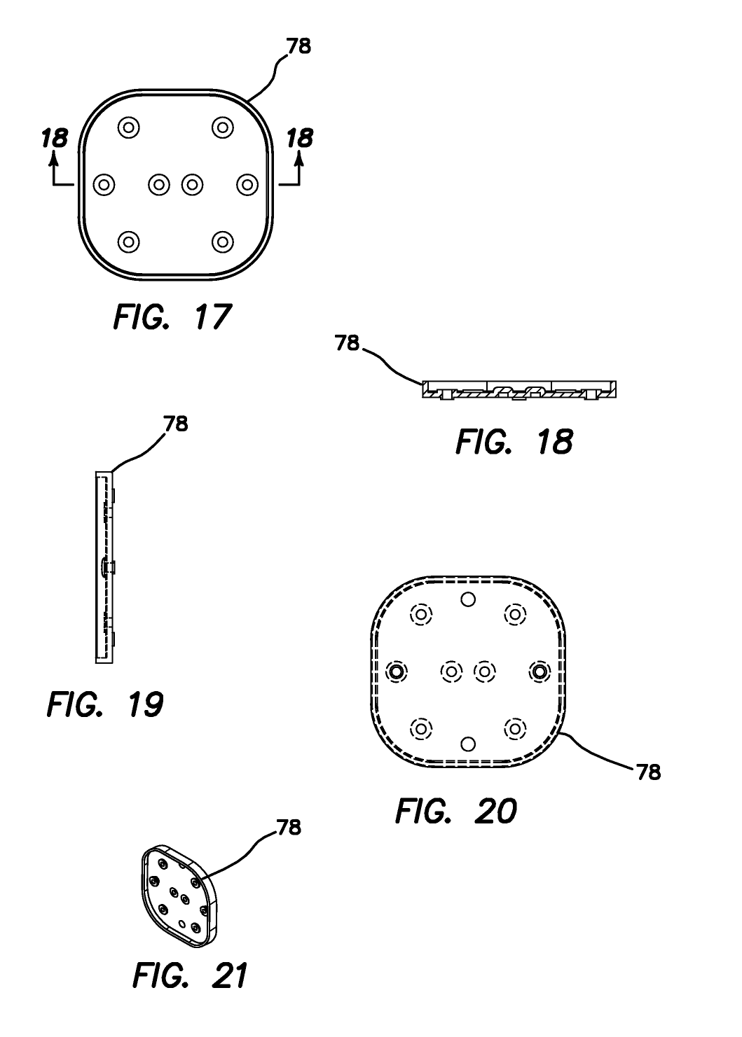

Additional features of the flow meter 26, and more particularly of the housing 56, include a gear cover assembly 78, and a sensor cover 80. Two alternative embodiments of the gear cover assembly 78 are illustrated in further detail in FIGS. 17-26. The gear cover assembly 78 may be secured to the flow meter body 64 using fasteners, such as screws 82 and nuts 84. The sensor 86 extends from a position within the sensor cavity beneath the sensor cover 80, in proximity to the Hall-effect magnets 74, 76 outside of the housing 56 through a sensor lead opening 88 in the flow meter body 64 and through a grommet 90. Mounting posts 92 are disposed on the body 64, for securing the flow meter to a suitable mounting location.

As noted above, the flow meter body 64 is illustrated in greater detail in FIGS. 11-16.

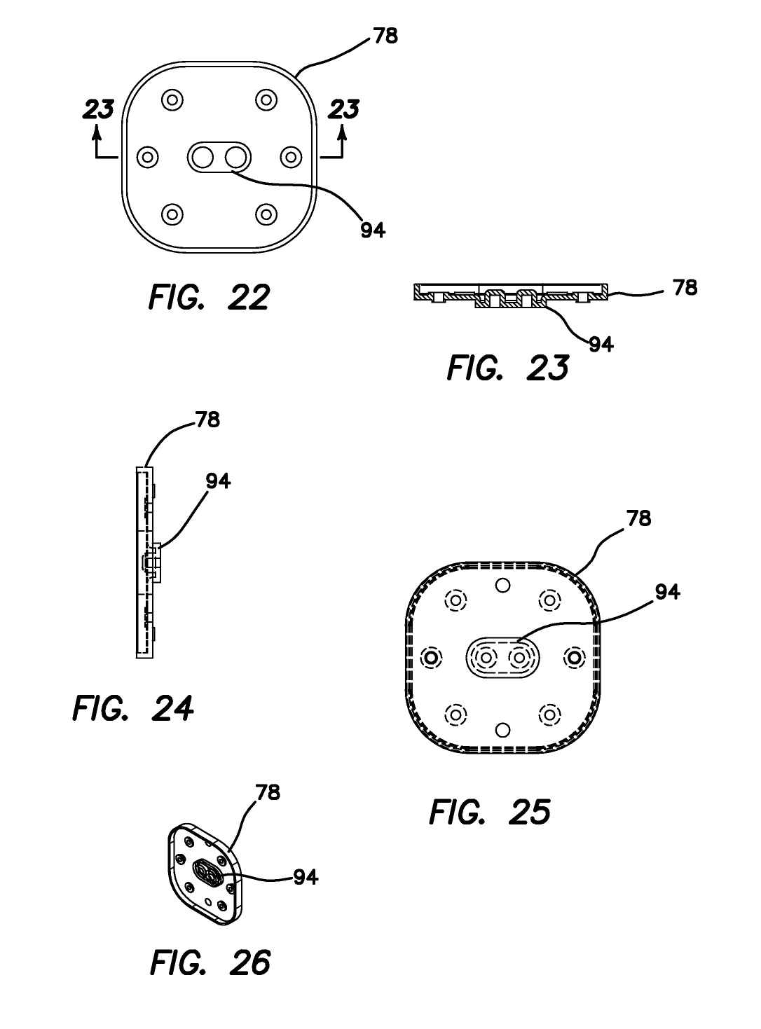

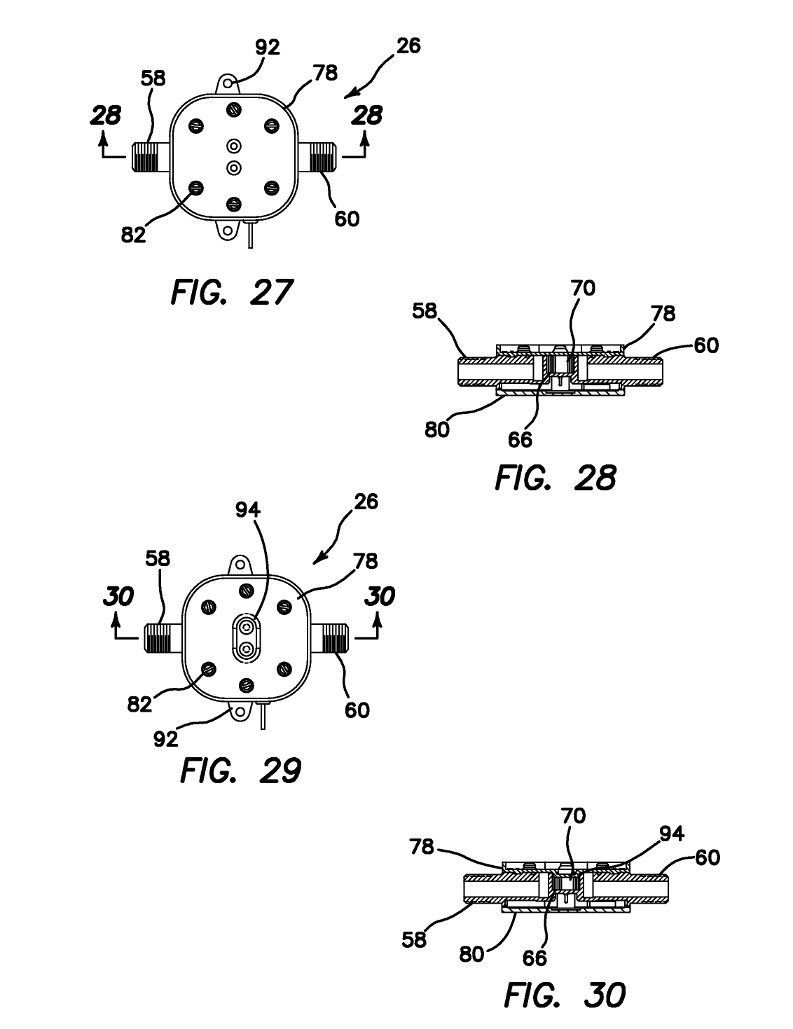

FIGS. 17-21 illustrate, in various views, the gear cover assembly 78 of the present invention. In particular, these figures illustrate an embodiment of the gear cover assembly 78 which is designed for a flow meter suitable for flows of approximately 4 L per minute. FIGS. 22-26 illustrate, in various views, a somewhat modified gear cover assembly 78 which is designed for a flow meter suitable for flows of approximately 1 L per minute. The two gear cover embodiments 78 are similar in most respects, but include some inventive features and differences which are best illustrated in conjunction with a review of FIGS. 27-30.

FIGS. 27 and 28 illustrate an embodiment of the flow meter 26 of the present invention which is adapted for a flow rate of approximately 4 liters (L) per minute. FIGS. 29 and 30 illustrate an embodiment of the flow meter 26 of the present invention which is adapted for a substantially smaller flow rate of approximately 1 L per minute. The two embodiments are substantially identical, except as noted herein and in the figures. Advantageously, when the larger flow rate capacity is desired, the oval gear 70 and the oval gear-magnet assembly 72 are maximized in size, to fill the available gear cavity 66, and a lower surface of the gear cover 78 is substantially flat. However, when it is desired to decrease the flow rate capacity of the flow meter 26, the vertical height of the oval gear 70 and oval gear-magnet assembly 72 is substantially lessened, as shown in FIG. 30. To fill the remaining space in the gear cavity 66, in order to ensure that the gears still substantially fill the vertical height of the cavity 66 for proper flow metering, a protruding step 94 is fabricated on the inner surface of the gear cover 78, so that it extends into the gear cavity 66 as shown in FIG. 30. This protruding step 94 is also shown in FIGS. 22-26, which illustrate the gear cover assembly for a lower flow rate flow meter.

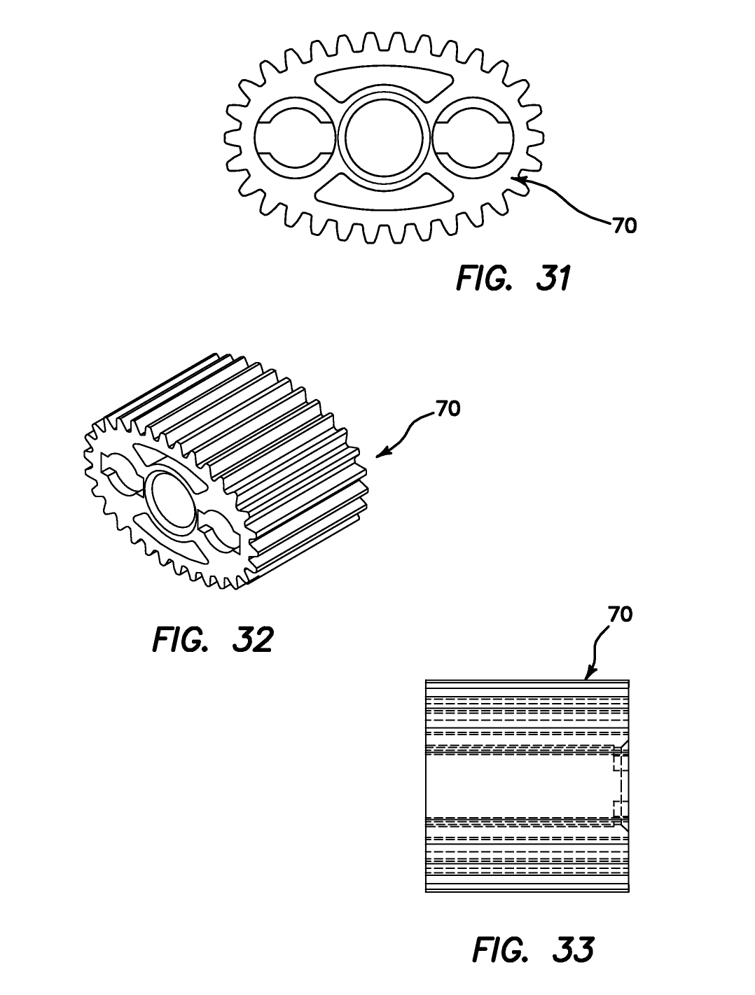

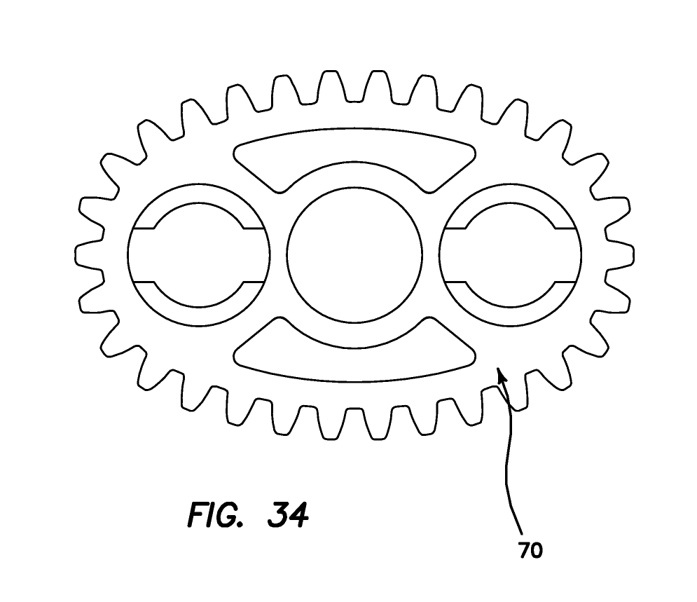

FIGS. 31-34 illustrate details of the oval gear 70. The gear design details shown herein also apply to the design of the oval gear-magnet assembly 72.

Now, with reference to the preceding figures, general operational principles of the inventive systems will be discussed. For the purpose of calibrating a fluid dispensing system 10, 38, a particular known liquid to be mixed in or dispensed from the system is pumped through a flow meter 26, and dispensed into a graduated cylinder or other reservoir 28, 50 having a known or measurable volume. When the desired volume of fluid has been pumped, as measured in the reservoir 28, 50, the number of rotations of the gears 70, 72 of the flow meter 26, as counted by the sensor 86, is recorded. Thereafter, it will always be known, simply by counting the number of rotations of the flow meter gearing 70, 72, what the dispensed volume of that particular fluid is. This procedure is repeated for each fluid to be mixed or dispensed in the system, and repeated at different temperatures if it is considered that temperature variations could be an issue. Then, when the system is later operated to mix and dispense fluids in an actual application process, the user merely programs into the controller 12, 40 the desired relative volumes of each fluid to be mixed into a given solution of a desired volume to be stored in reservoir 28, 50. The resultant solution is always consistent, because volumetric flows through the flow meters 26 are consistent. System degradations are compensated for by lengthening the time of operation of the system to attain the desired mixed solution volume.

Other operational uses for the inventive flow meters include a visual and/or audible alarm 32, to be triggered when the system detects that the rotation of the gearing 70, 72 is outside of a specified tolerance range (indicative that the system is out of a particular chemical, the wrong chemical is being delivered through that flow meter, or the fluid line is clogged), or that two incompatible chemicals are being delivered through the system at the same time. An example of this latter issue could be a potentially deadly mixture of ammonia and bleach. The alarm may be set to automatically shut down the dispensing system, if desired.

Accordingly, although an exemplary embodiment of the invention has been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A chemical fluid dispensing system, comprising:
a controller having a microprocessor and a user interface;
a first pump for pumping a first fluid through a first fluid line into a mixing chamber;
a second pump for pumping a second fluid through a second fluid line into the mixing chamber;
a first flow meter disposed in said first fluid line;
a second flow meter disposed in said second fluid line; and
a feedback loop extending from each of said first and second flow meters back to said controller, for closed loop control of said system.

2. The chemical fluid dispensing system as recited in claim 1, wherein each of said first and second flow meters comprise positive displacement flow meters.

3. The chemical fluid dispensing system as recited in claim 1, and further comprising an alarm for indicating an out of tolerance fluid flow volume through one of said first and second flow meters.

4. The chemical fluid dispensing system as recited in claim 1, and further comprising a check valve in said first fluid line between said first pump and said first flow meter.

5. The chemical fluid dispensing system as recited in claim 1, and further comprising a check valve in said first fluid line between said first flow meter and said mixing chamber.

6. The chemical fluid dispensing system as recited in claim 1, and further comprising a water inlet assembly for delivering water through a third fluid line into the mixing chamber.

7. The chemical fluid dispensing system as recited in claim 6, and further comprising a third flow meter disposed in said third fluid line.

8. The chemical fluid dispensing system as recited in claim 1, wherein each of said first and second flow meters comprise positive displacement flow meters.

9. The chemical fluid dispensing system as recited in claim 8, wherein each positive displacement flow meter comprises:
a flow meter housing, comprising a flow meter body having a gear cavity, a fluid inlet, a fluid outlet, a gear cover assembly, and a sensor cover;
a gear which may be disposed on a first gear post in said gear cavity;
a gear-magnet assembly which may be disposed on a second gear post in said gear cavity; and
a sensor for counting rotations of the gear-magnet assembly.

10. The chemical fluid dispensing system as recited in claim 9, wherein said sensor comprises a Hall-effect sensor.

11. The chemical fluid dispensing system as recited in claim 9, wherein said gear cover assembly comprises a protruding step which extends downwardly into the gear cavity when the gear cover assembly is attached to the flow meter body.

12. The chemical fluid dispensing system as recited in claim 11, wherein the protruding step extends downwardly a first predetermined distance when the flow meter is adapted for a first predetermined flow rate, and a different second predetermined distance when the flow meter is adapted for a second different predetermined flow rate.

13. The chemical fluid dispensing system as recited in claim 9, wherein the gear and the gear magnet assembly have a first predetermined vertical height when the flow meter is adapted for a first predetermined flow rate, and a different second predetermined height when the flow meter is adapted for a second different predetermined flow rate.

14. The chemical fluid dispensing system as recited in claim 9, wherein said gear and said gear-magnet assembly are each oval in configuration.

15. A positive displacement flow meter, comprising:
a flow meter housing, comprising a flow meter body having a gear cavity, a fluid inlet, a fluid outlet, a gear cover assembly, and a sensor cover;
a gear which may be disposed on a first gear post in said gear cavity;
a gear-magnet assembly which may be disposed on a second gear post in said gear cavity; and
a sensor for counting rotations of the gear-magnet assembly.

16. The flow meter as recited in claim 15, wherein said sensor comprises a Hall-effect sensor.

17. The flow meter as recited in claim 15, wherein said gear cover assembly comprises a protruding step which extends downwardly into the gear cavity when the gear cover assembly is attached to the flow meter body.

18. The flow meter as recited in claim 17, wherein the protruding step extends downwardly a first predetermined distance when the flow meter is adapted for a first predetermined flow rate, and a different second predetermined distance when the flow meter is adapted for a second different predetermined flow rate.

19. The flow meter as recited in claim 15, wherein the gear and the gear magnet assembly have a first predetermined vertical height when the flow meter is adapted for a first predetermined flow rate, and a different second predetermined height when the flow meter is adapted for a second different predetermined flow rate.

20. The flow meter as recited in claim 15, wherein said gear and said gear-magnet assembly are each oval in configuration.

21. A method of calibrating a fluid dispensing system, comprising:
pumping a liquid, having known flow characteristics, through a flow meter and into a reservoir having a known or measurable volume;
counting the number of rotations of a gear in the flow meter while the known volume of fluid is pumped through the flow meter; and
recording said number of rotations and the known volume of fluid.

22. The method as recited in claim 21, wherein the pumping, counting, and recording steps are repeated for a second liquid having different known flow characteristics.

23. The method as recited in claim 21, wherein the pumping, counting, and recording steps are repeated at different ambient temperatures.

24. A method of modifying a fluid flow capacity of a positive displacement flow meter comprising a flow meter body having a gear cavity, a fluid inlet, and a fluid outlet, the method comprising:
removing a first gear cover assembly having a protruding step which extends a particular distance downwardly into the gear cavity when the first gear cover assembly is attached to the flow meter body;
removing a first set of gears having a first predetermined vertical height from said gear cavity;
replacing said first set of gears with a second set of gears having a second predetermined vertical height; and
attaching a second gear cover assembly having a protruding step which extends a different particular distance downwardly into the gear cavity to said flow meter body.
